(19) United States
(12) Patent Application Publication
(10) Pub. No.: US 2026/0209087 A1
(43) Pub. Date: Jul. 23, 2026

(54) WASTEWATER CONCENTRATION DEVICE AND CONCENTRATION METHOD

(71) Applicants: KURITA WATER INDUSTRIES LTD., Tokyo (JP); NATIONAL UNIVERSITY CORPORATION KOBE UNIVERSITY, HYOGO (JP)

(72) Inventors: Takahiro KAWAKATSU, Tokyo (JP); Taeko NAKAMURA, Tokyo (JP); Hideki GOTO, Tokyo (JP); Kazuo KUMAGAI, Hyogo (JP); Hideto MATSUYAMA, Hyogo (JP)

(73) Assignees: KURITA WATER INDUSTRIES LTD., Tokyo (JP); NATIONAL UNIVERSITY CORPORATION KOBE UNIVERSITY, HYOGO (JP)

(21) Appl. No.: 19/141,329

(22) PCT Filed: Oct. 10, 2023
(86) PCT No.: PCT/JP2023/036757

§ 371 Date: Jun. 20, 2025

(30) Foreign Application Priority Data
Mar. 2, 2023 (JP) 2023-032056

(51) Int. Cl. C02F 1/44; C02F 101/34

(52) U.S. Cl. CPC C02F 1/441; C02F 2101/34; C02F 2301/04; C02F 2303/10

(57) ABSTRACT

Provided is a wastewater concentration device comprising: reverse osmosis membrane devices 5 and 8 to which wastewater is supplied; a pressure recovery device 20 that recovers pressure from concentrated water supplied from the reverse osmosis membrane devices; and osmotic pressure-assisted reverse osmosis membrane devices 31, 33, and 35 through which the concentrated water that has passed through the pressure recovery device flows.

### TECHNICAL FIELD

The present invention relates to a wastewater concentration device, particularly to a wastewater concentration device using reverse osmosis method and osmotically assisted reverse osmosis method. Further, the present invention relates to a wastewater concentration method using this concentration device.

### RELATED ART

There have been many attempts to concentrate waste liquid to recover valuable materials or reduce industrial waste costs. In the electronics industry, large amounts of isopropyl alcohol (IPA) are used, and there is a movement to recover and reuse it from the perspective of resource conservation and decarbonization.

Conventionally, evaporation method and reverse osmosis method (RO method) have been generally used as methods for concentrating wastewater. In the evaporation method, the challenge is high energy consumption due to the phase change of water. By using a reverse osmosis (RO) membrane, energy consumption reduction is expected as it does not involve water phase change. However, as the osmotic pressure of the wastewater increases, high pressure must be applied, requiring high pressure specification devices. To concentrate an IPA aqueous solution with a concentration of 1 to 5 wt % to an IPA concentration of 15 wt % or higher, a pressure of 10 MPa or more is necessary, which is not practical.

When concentrating a high osmotic pressure aqueous solution using a reverse osmosis (RO) membrane, there is an osmotically assisted reverse osmosis method (OARO method) in which an aqueous solution with a lower osmotic pressure than the supply water side is passed through the permeate water side to reduce the osmotic pressure difference and lower the driving pressure (Patent Literature 1, etc.).

In the OARO method, since liquid is also passed through the permeate side, hollow fiber RO membranes are structurally suitable. Hollow fiber RO membranes are commercially available from Toyobo Co., Ltd. as BC (Brine Concentration) membranes. It is noted that since the material of the BC membrane is cellulose acetate, it is desirable to maintain the pH between 3 and 8.

In the OARO method, it is possible to concentrate wastewater at a lower pressure than the conventional RO method. However, because a portion of the concentrated water is recirculated, more stages are required in the device compared to the RO method. Thus, in the OARO method, to avoid high-pressure operation and reduce the number of device stages, it is effective to use a flow (RO+OARO method) where initial concentration is performed by the RO method to some extent, followed by concentration using the OARO method.

When adopting this RO+OARO method, a pressure of about 2 to 6 MPa is required for each of the RO method and OARO method. In the case of concentration using the RO method alone, a pressure of 10 MPa or more is necessary. Thus, the RO+OARO method reduces the operation pressure compared to the RO method alone.

In a method of recovering the pressure of the concentrated water from the RO device in the RO method and using the same to pressurize the supply water for the RO method, or a method of recovering the pressure of the concentrated water from the OARO method and using the same to pressurize the supply water for the OARO method, the ratio of concentrated water to supply water is often 1/5 or less, and thus does not result in significant energy savings. Further, there is a problem that the system operation becomes complex. Furthermore, there is a risk of the issue of mixing between the concentrated water and the supply water.

### CITATION LIST

### Patent Literature

Patent Literature 1: Japanese Patent Application Laid-Open Publication No. 2019-504763.

### SUMMARY OF INVENTION

### Technical Problem

In a process using the RO+OARO method, if the pressure retained by the concentrated water from the upstream RO device is effectively utilized, the energy consumption may be further reduced.

The present invention aims to provide a wastewater concentration device and concentration method that may effectively utilize the pressure retained by the concentrated water from the upstream RO device in a wastewater concentration device and concentration method where the OARO method is applied downstream of the RO method.

### Solution to Problem

The summary of the present invention is as follows.

[1] A wastewater concentration device that includes: a reverse osmosis membrane device to which wastewater is supplied;

a pressure recovery device, recovering pressure from concentrated water from the reverse osmosis membrane device; and

an osmotic pressure-assisted reverse osmosis membrane device through which concentrated water that has passed through the pressure recovery device flows.

[2] The wastewater concentration device according to [1] in which the pressure recovery

device is configured to allow the concentrated water to flow through a primary side passage and pressurize water flowing through a secondary side passage by a pressure of the concentrated water.

[3] The wastewater concentration device according to [2] that includes: a tank, accepting concentrated water that has passed through the primary side passage; and a first supply means, supplying at least a portion of the concentrated water in the tank to the osmotic pressure-assisted reverse osmosis membrane device through a secondary side passage of the pressure recovery device.

[4] The wastewater concentration device according to [3] in which the first supply means includes a booster pump for boosting concentrated water that has passed through the second side passage.

[5] A wastewater concentration device that includes: a reverse osmosis membrane device

to which wastewater is supplied;

a first energy recovery device, recovering retained energy of concentrated water from the reverse osmosis membrane device as electrical energy; and

an osmotic pressure-assisted reverse osmosis membrane device through which concentrated water that has passed through the first energy recovery device flows.

[6] The wastewater concentration device according to [5] that includes a second energy recovery device that recovers retained energy of concentrated water from the osmotic pressure-assisted reverse osmosis membrane device as electrical energy.

[7] A wastewater concentration method for concentrating wastewater using the wastewater concentration device according to any one of [1] to [6].

[8] The wastewater concentration method according to [7] in which the wastewater is isopropyl alcohol-containing water.

### Effects of Invention

In the present invention, in a flow where an OARO device is placed downstream of an RO device, the pressure of the concentrated water from the RO device is recovered by a pressure recovery device or an energy recovery device. All or part of the recovered pressure or energy may be used to pressurize the supply water of the OARO device.

As mentioned earlier, to concentrate high osmotic pressure wastewater using only an RO device, a high pressure specification RO device is necessary. Further, in the case of concentrating high osmotic pressure wastewater using only an OARO device, it is possible to reduce the operation pressure compared to concentrating using only an RO device, but it requires a large number of stages. In the present invention, since the wastewater is passed through the OARO device after being concentrated to a certain extent by the RO device, a smaller number of stages in the OARO device is sufficient.

According to an aspect of the present invention, the pressure possessed by the concentrated water from the RO device is recovered by the pressure recovery device and used to pressurize the feed water of the OARO device. In this case, it is possible to utilize almost all of the pressure energy of the concentrated water from the RO device for pressurizing the feed water of the OARO device. Moreover, in this case, since the concentrated water from the RO device and the feed water to the OARO device are identical, even if they mix, it does not cause any problems, and the system operation does not become complicated.

According to an aspect of the present invention, the concentrated water from the RO device is temporarily received in a tank before being supplied to the OARO device. In this aspect, chemicals such as pH adjusting agents may be added to the water in the tank, or other treatments may be applied to make it the supply water for the OARO device.

In an aspect of the present invention, the pressure energy possessed by the concentrated water from the RO device is recovered as electrical energy. There is no particular limitation on the use of the recovered electrical energy, but it may be used as driving power for the pump for sending the RO concentrated water supplied to the OARO device or for the boosting pump.

### BRIEF DESCRIPTION OF DRAWINGS

FIG. 1 is a configuration diagram of the wastewater concentration device according to an embodiment of the present invention.

FIG. 2 is a configuration diagram of the wastewater concentration device according to an embodiment of the present invention.

FIG. 3 is a configuration diagram of the wastewater concentration device according to an embodiment of the present invention.

FIG. 4 is a graph showing experimental results.

FIG. 5 is a graph showing experimental results.

FIG. 6 is a configuration diagram of a test device.

FIG. 7 is a configuration diagram of a test device.

FIG. 8 is a configuration diagram of the wastewater concentration device according to an embodiment of the present invention.

### DESCRIPTION OF EMBODIMENTS

Embodiments are described below with reference to the drawings.

### First Embodiment

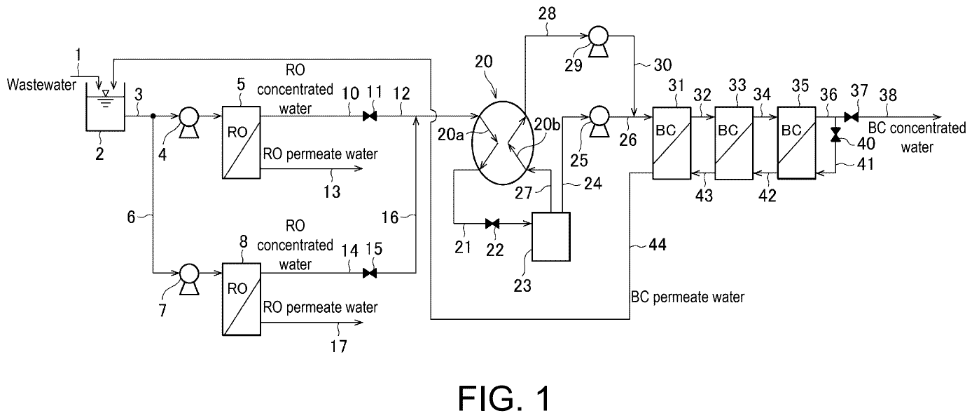

FIG. 1 is a configuration diagram of the wastewater concentration device according to the first embodiment of the present invention. Wastewater (raw wastewater) to be treated is introduced into a raw water tank 2 through a raw water pipe 1. The raw wastewater in the raw water tank 2 is sent via a pipe 3 and a pump 4 to a first RO device 5 using a conventional RO method. A pipe 6 branches from the pipe 3, and a portion of the raw wastewater is sent via the pipe 6 and a pump 7 to a second RO device 8 using a conventional RO method.

The concentrated water from the first RO device 5 and the second RO device 8 is sent to flow through a primary side passage 20a of a pressure recovery device 20 via a pipe 10, a valve 11, a merging pipe 12 or a pipe 14, a valve 15, a pipe 16, and a merging pipe 12, respectively. It is noted that the permeate water from the RO devices 5 and 8 is extracted from the system through pipes 13 and 17, respectively.

The pressure recovery device 20 is configured to pressurize the water flowing through a secondary side passage 20b by the pressure of the water flowing through the primary side passage 20a. The water that has passed through the primary side passage 20a flows into a supply water tank 23 via a pipe 21 and a valve 22. Although not shown in the figure, a chemical addition device may be installed to add chemicals to this supply water tank 23.

A portion of the water in the supply water tank 23 is sent to the concentrated water chamber of a BC membrane device 31 as an OARO device through a pipe 24, a pump 25, and a pipe 26. Further, a portion of the water in the supply water tank 23 is pressurized and boosted by flowing through the secondary side passage 20b of the pressure recovery device 20 via a pipe 27. The boosted water is sent to a booster pump 29 through a pipe 28, and after being further pressurized and boosted, it merges with the pipe 26 through a pipe 30 and is supplied to the concentrated water chamber of the BC membrane device 31.

In this embodiment, three BC membrane devices 31, 33, and 35 are arranged in series. The concentrated water from the BC membrane device 31 is passed through a pipe 32 to the concentrated water chamber of the BC membrane device 33, and its concentrated water is passed through a pipe 34 to the concentrated water chamber of the BC membrane device 35. A portion of the concentrated water from the BC membrane device 35 is extracted as BC concentrated water through a pipe 36, a valve 37, and a pipe 38.

The remaining portion of the concentrated water from the BC membrane device 35 is passed through the permeate water chamber of the BC membrane device 35 via a pipe 41, which branches from the pipe 36, and a valve 40. The outflow water from the permeate water chamber of the BC membrane device 35 is passed through the permeate water chamber of the BC membrane device 33 via a pipe 42, and its outflow water is passed through the permeate water chamber of the BC membrane device 31 via a pipe 43. The outflow water from the permeate water chamber of the BC membrane device 31 is returned to the raw water tank 2 through a pipe 44.

In this embodiment, the BC membrane device consists of three BC membrane devices 31, 33, and 35, but the number of BC membrane devices is not limited thereto. Further, the number of BC membranes constituting each BC membrane device may be one or two or more. The total number of BC membranes in the BC membrane devices is preferably about 3 to 30.

In this manner, pressure recovery is performed by using the pressure recovery device 20 to impart the pressure retained in the concentrated water from the RO devices 5 and 8 to the feed water of the BC membrane device.

As the pressure recovery device, a volumetric power recovery type pressure recovery device or a turbocharger type pressure recovery device may be used. As examples of the former, DeROs (registered trademark) by Dengyosha Machine Works and iSave by Danfoss may be mentioned. As an example of the latter, HPB by Fedco may be mentioned.

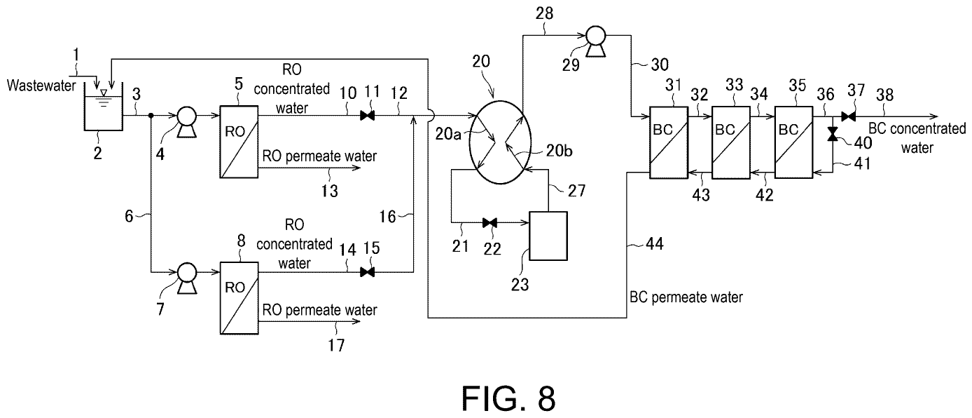

It is noted that in FIG. 1, a portion of the water in the supply water tank 23 is supplied to the BC membrane device 31 through the pipe 24, the pump 25, and the pipe 26. However, as shown in FIG. 8, the entire amount of water in the supply water tank 23 may be arranged to flow through the secondary side passage 20b of the pressure recovery device 20.

### Second Embodiment

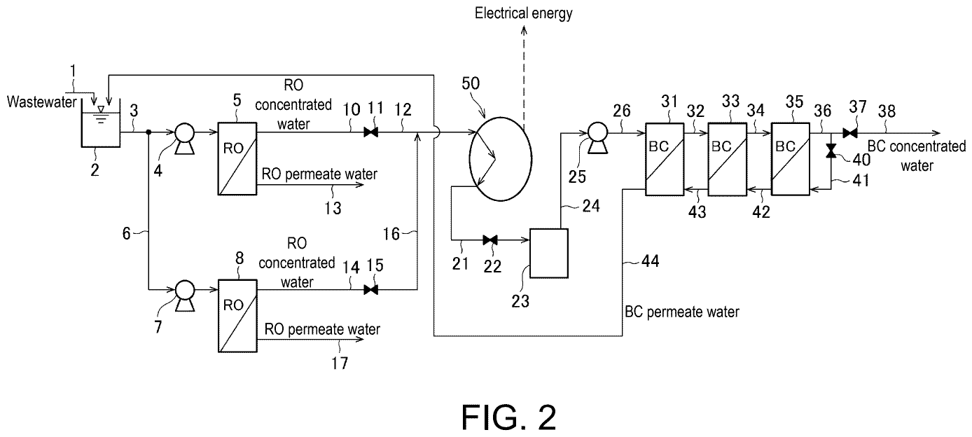

FIG. 2 is a configuration diagram of the wastewater concentration device according to the second embodiment. In this embodiment, an energy recovery device 50 is installed instead of the pressure recovery device 20 in the wastewater concentration device of FIG. 1, and it is arranged to recover the pressure energy of the concentrated water from the RO devices 5 and 8 as electrical energy. As the energy recovery device 50, one equipped with a Pelton water turbine and a generator driven by the Pelton water turbine is preferable, but it is not limited thereto.

In the wastewater concentration device of FIG. 2, pipes 27, 28, 30, and the booster pump 29 are not installed.

The other configurations of the wastewater concentration device in FIG. 2 are identical to those of the wastewater concentration device in FIG. 1, and the same reference numerals indicate the same parts.

### Third Embodiment

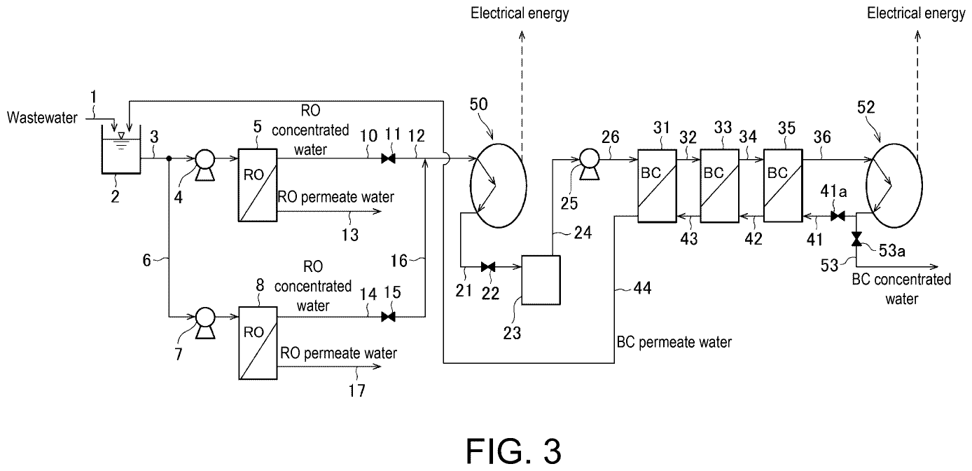

FIG. 3 is a configuration diagram of the wastewater concentration device according to the third embodiment. In this embodiment, in the wastewater concentration device of FIG. 2, the entire amount of concentrated water from the BC membrane device 35 is introduced to a second energy recovery device 52 through pipe the 36 to recover energy as electrical power. A portion of the concentrated water that has passed through the second energy recovery device 52 is sent to the permeate water chamber of the BC membrane device 35 through the pipe 41 and a valve 41a, and the remaining portion is extracted through a valve 53a and a pipe 53.

The other configurations in FIG. 3 are identical to those in FIG. 2, and the same reference numerals indicate the same parts.

### OTHER EMBODIMENTS

In an aspect of the present invention, when concentrating high pH RO concentrated water using an OARO device, pretreatment is performed with a cation exchange resin to remove cation components contributing to the high pH, while simultaneously lowering the pH of the wastewater by hydrogen ions released through ion exchange. Further, when concentrating low pH RO concentrated water using an OARO device, pretreatment is performed with an anion exchange resin to remove anion components contributing to the low pH, while simultaneously raising the pH of the wastewater by hydroxide ions released through ion exchange.

By treating the concentrated water from the upstream RO device with an ion exchange resin in the RO+OARO method, it becomes possible to simultaneously reduce salt concentration and adjust pH for both high pH RO concentrated water and low pH RO concentrated water.

By setting the pH of the water passing through the OARO device (osmotic pressure-assisted reverse osmosis device) to 3 to 8, stable concentration treatment may be performed over a long period without degradation, even if the osmotic pressure-assisted reverse osmosis membrane is a cellulose acetate membrane. It is noted that the osmotic pressure-assisted reverse osmosis membrane is not limited to a cellulose acetate membrane.

### EXAMPLES

### Test Example 1: Concentration Test of IPA Aqueous Solution Using Ultra-Low Pressure RO Membrane and Seawater (for Seawater Desalination) RO Membrane

### Test objective

The test objective was to investigate the relationship between operating pressure and IPA (isopropyl alcohol) concentration when concentrating IPA aqueous solution using ultra-low pressure RO membrane and seawater desalination RO membrane.

### Test method

A flat membrane test device with a membrane area of 13 cm² was equipped with the ultra-low pressure RO membrane or seawater desalination RO membrane described below, and the concentrated water IPA concentration was measured by changing the operating pressure. The test conditions were as follows.
Ultra-low pressure RO membrane: Nitto Denko Corporation ES20
Seawater desalination RO membrane: Nitto Denko Corporation SWC4
Raw water: IPA aqueous solution prepared by adding IPA to ultrapure water to achieve IPA concentrations of 0.12 wt %, 0.65 wt %, or 1.2 wt %, and adjusted to pH 11 using sodium hydroxide
Operating pressure: 0.5 to 4.5 MPa
Set permeate flux: 0.6 m/d (in the case of ultra-low pressure RO membrane)
   0.45 m/d (in the case of seawater desalination RO membrane)
Recovery rate: 0.6 to 0.95
Water temperature: 25° C.
Concentrated water IPA concentration measurement method: TOC analyzer (TOC-L, Shimadzu Corporation), Gas chromatography (GC-2014, Shimadzu Corporation, analysis conditions: Column: Porapak-Q50-80 (length 3 m, inner diameter 3 mm, Shimadzu Corporation), Column temperature: 200° C., Vaporization chamber temperature: 210° C., Detector (temperature): TCD (210° C.), Carrier gas: Helium 40 mL/min)

### Results

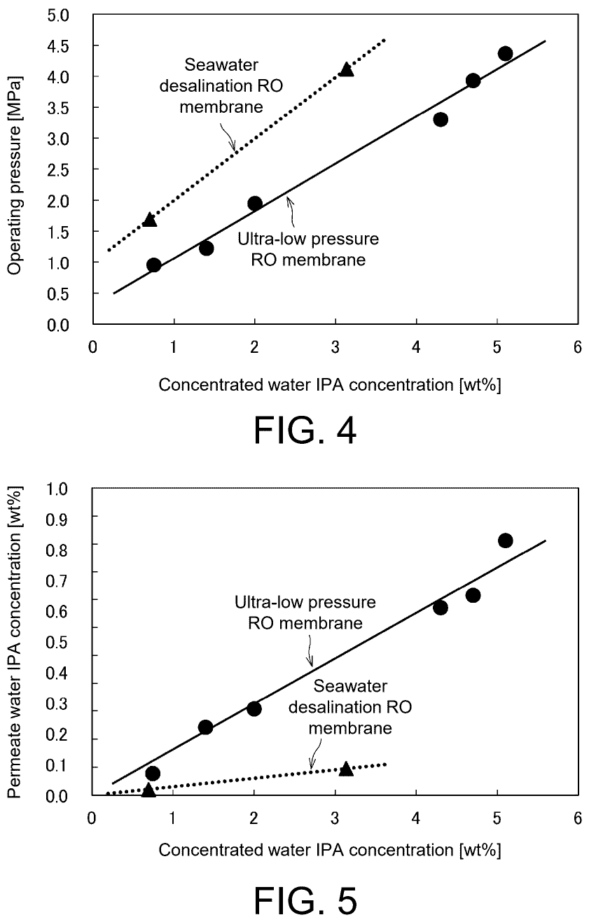

The relationship between concentrated water IPA concentration and operating pressure is shown in FIG. 4. Further, the relationship between concentrated water IPA concentration and permeate water IPA concentration is shown in FIG. 5. As shown in FIG. 4, as the concentrated water concentration increased, the operating pressure increased almost linearly. The relationship equation when linearly approximated was as follows. It is noted that the IPA rejection rate was approximately 85% for the ultra-low pressure RO membrane and approximately 97% for the seawater desalination RO membrane.

$$Ultra - low pressure RO membrane : Operating pressure [ MPa ] = 0.763 \times [ Concentrated water IPA concentration ( wt \% ) ] + 0.301$$

$$Seawater desalination RO membrane : Operating pressure [ MPa ] = 0.994 \times [ Concentrated water IPA concentration ( wt \% ) ] + 1.003$$

As shown in FIG. 4, in the case of the ultra-low pressure RO membrane, an operating pressure of 4.1 MPa or higher was required to achieve a concentrated water IPA concentration of 5 wt % or higher. In the case of the seawater desalination RO membrane, due to its high IPA rejection rate, an operating pressure of 6 MPa or higher was required to achieve a concentrated water IPA concentration of 5 wt % or higher. Further, even when using the ultra-low pressure RO membrane to achieve a concentrated water IPA concentration of 2.2 wt %, an operating pressure of 2 MPa or higher was required. Based on these test results, it is recognized that pressure recovery and energy recovery are desirable.

### Test Example 2: Water Passage Test of IPA Aqueous Solution Through Two-Stage BC Membrane Devices in Series

### Test Objective

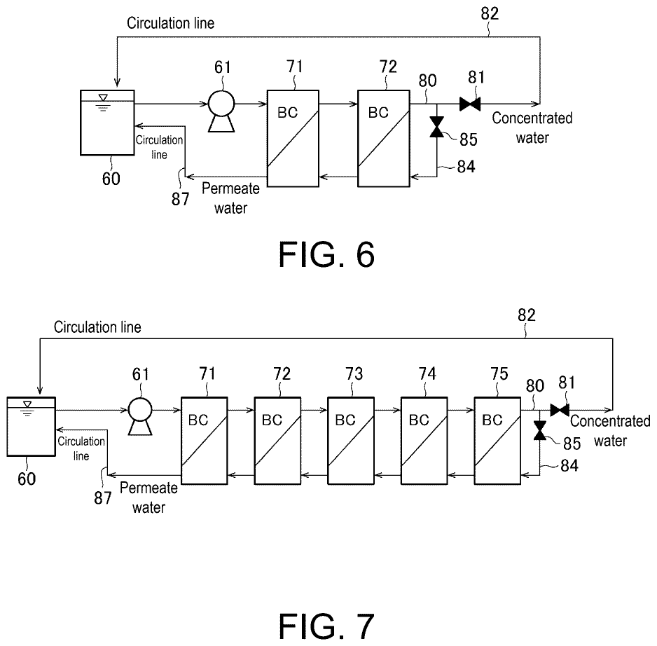

As shown in FIG. 6, the test objective was to measure the operating pressure when passing the IPA aqueous solution through a test device with two BC membrane devices 71 and 72 installed in two stages in series for concentration.

### Test Device

As shown in FIG. 6, the IPA aqueous solution in the tank 60 was supplied to the first BC membrane device 71 by the pump 61, its concentrated water was supplied to the concentrated water chamber of the second BC membrane device 72, and a portion of the concentrated water was returned to the tank 60 through the pipe 80, the valve 81, and the pipe 82. The remaining portion of the concentrated water from the second BC membrane device 72 was passed through the permeate water chamber of the second BC membrane device 72 via the pipe 84 branching from the pipe 80 and the valve 85, and further passed through the permeate water chamber of the first BC membrane device 71, and then returned to the tank 60 through the pipe 87.

### Test Conditions

IPA aqueous solution in the tank 60; ultrapure water with 1.1 wt % IPA added and adjusted to pH 4 with hydrochloric acid
BC membrane devices 71, 72: Toyobo Co., Ltd. BC membrane module Hollosep Mini (registered trademark), membrane area 1.1 m² (water to be treated is passed on the outside of the hollow fiber membrane)
Pump 61 liquid feed flow rate: 120 mL/min
Operating pressure: 5.5 MPa
Concentrated water flow rate from BC membrane device 72:15.6 mL/min
Concentrated water flow rate in pipe 84:6 mL/min
Water temperature: 25° C.

### Results

The IPA-containing water with an IPA concentration of 1.1 wt % was concentrated to 5.4 wt %.

Since the operating pressure was 5.5 MPa, it was recognized that pressure recovery and energy recovery of the RO concentrated water were effective.

### Test Example 3: Water Passage Test of IPA Aqueous Solution Through Five-Stage BC Membrane Devices in Series

### Test Objective

As shown in FIG. 7, the test objective was to measure the liquid feed flow rate, operating pressure, and concentrated water IPA concentration when passing the IPA aqueous solution through a test device with BC membrane devices 71 to 75 installed in five stages in series for concentration.

### Test Device

As shown in FIG. 7, the device was identical to that in FIG. 6 except that BC membrane devices 71 to 75 were installed in five stages in series.

### Test Conditions

As the water to be treated, an IPA aqueous solution (water temperature 25° C.) with pH 7 was used, prepared by adding 4.9 to 5.4 wt % IPA to ultrapure water.

The liquid was sent to the outside of the hollow fiber membrane by the pump 61 at a liquid feed flow rate of 50 to 100 mL/min and an operating pressure of 4.7 to 6.0 MPa, the concentrated liquid discharged from the BC membrane module was recovered at a rate of 2 to 35 mL/min via the pipe 82, and the remainder was passed through the inside (permeate side) of the hollow fiber membrane of each BC membrane device 75 to 71.

### Results

The pump 61 liquid feed flow rate, operating pressure, and concentrated water IPA concentration are shown in Table 1. As shown in Table 1, when the liquid feed flow rate was reduced, the concentrated water IPA concentration increased. At a liquid feed flow rate of 100 mL/min, the concentrated water IPA concentration was 11.4 wt % at an operating pressure of 5.0 MPa, but it became 18.9 wt % at 6.0 MPa. By reducing the liquid feed flow rate, it was possible to lower the operating pressure required to obtain a predetermined concentrated water IPA concentration. However, an operating pressure of 2 MPa or more is necessary, and pressure recovery and energy recovery are effective.

TABLE 1

| IPA | Liquid feed | Operating | Concentrated water |
|---|---|---|---|
| concentration | flow rate | pressure | IPA concentration |
| (wt %) | (mL/min) | (MPa) | (wt %) |
| 4.9 | 50 | 4.7 | 28.9 |
| 5.2 | 60 | 5.0 | 20.7 |
| 5.3 | 80 | 5.0 | 15.5 |
| 5.4 | 100 | 4.7 | 11.4 |
| 5.3 | 100 | 6.0 | 18.9 |

The present invention has been described in detail using specific embodiments, but it is clear to those skilled in the art that various changes are possible within the range where the effects of the invention are achieved.

This application is based on Japanese Patent Application No. 2023-032056 filed on Mar. 2, 2023, the entire contents of which are incorporated herein by reference.

### REFERENCE SIGNS LIST

5, 8 RO device
20 Pressure recovery device
20a Primary side passage
20b Secondary side passage
29 Booster pump
31, 33, 35, 71~75 BC membrane device
50, 52 Energy recovery device

1. A wastewater concentration device, comprising:
a reverse osmosis membrane device to which wastewater is supplied;
a pressure recovery device, recovering pressure from concentrated water from the reverse osmosis membrane device; and
an osmotic pressure-assisted reverse osmosis membrane device through which concentrated water that has passed through the pressure recovery device flows.

2. The wastewater concentration device according to claim 1, wherein the pressure recovery device is configured to allow the concentrated water to flow through a primary side passage and pressurize water flowing through a secondary side passage by a pressure of the concentrated water.

3. The wastewater concentration device according to claim 2, comprising:
a tank, accepting concentrated water that has passed through the primary side passage; and
a first supply means, supplying at least a portion of the concentrated water in the tank to the osmotic pressure-assisted reverse osmosis membrane device through a secondary side passage of the pressure recovery device.

4. The wastewater concentration device according to claim 3, wherein the first supply means comprises a booster pump for boosting concentrated water that has passed through the secondary side passage.

5. A wastewater concentration device, comprising:
a reverse osmosis membrane device to which wastewater is supplied;
a first energy recovery device, recovering retained energy of concentrated water from the reverse osmosis membrane device as electrical energy; and
an osmotic pressure-assisted reverse osmosis membrane device through which concentrated water that has passed through the first energy recovery device flows.

6. The wastewater concentration device according to claim 5, comprising a second energy recovery device that recovers retained energy of concentrated water from the osmotic pressure-assisted reverse osmosis membrane device as electrical energy.

7. A wastewater concentration method for concentrating wastewater using the wastewater concentration device according to claim 1.

8. The wastewater concentration method according to claim 7, wherein the wastewater is isopropyl alcohol-containing water.
